(19) United States
(12) Patent Application Publication
(10) Pub. No.: US 2009/0055044 A1
(43) Pub. Date: Feb. 26, 2009

(54) MOTOR VEHICLE SERVICING SYSTEM AND METHOD WITH AUTOMATIC DATA RETRIEVAL AND LOOKUP OF FLUID REQUIREMENTS

(75) Inventor: Dale Dienst, Wesley Chapel, FL (US)

Correspondence Address: MARK YOUNG, P.A., 12086 FORT CAROLINE ROAD, UNIT 202, JACKSONVILLE, FL, 32225, US

(73) Assignee: INNOVATIVE PRODUCTS ALLIANCE, LLC, ST. AUGUSTINE, FL (US)

(21) Appl. No.: 11/845,081

(22) Filed: Aug. 26, 2007

(51) Int. Cl. G01M 17/007; G06F 17/30

(52) U.S. Cl. 701/32; 701/33

(57) ABSTRACT

A system for electronically determining vehicle data, such as a vehicle identification number (VIN), of a serviced vehicle, correlating the data with vehicle refrigerant requirements, and controlling servicing equipment according to the requirements, includes an OBD II interface and a module configured to automatically determine the vehicle data from the ECU through the OBD II port. The module may, for example, determine a year, make and model from a VIN and correlate that information with charging requirement data for the vehicle. The charging requirement data is supplied to the microcontroller of a recharging station.

### FIELD OF THE INVENTION

This invention relates to vehicle servicing, and more particularly, to a system and method for electronically determining vehicle data, such as a vehicle identification number (VIN), of a serviced vehicle, correlating the VIN with vehicle fluid requirements, and controlling servicing equipment according to the requirements.

### BACKGROUND

Vehicles require periodic replacement of fluids, such as refrigerant, motor oil, transmission fluid, power steering fluid, brake fluid, differential oil, and coolant, just to name a few. Such fluids must be periodically replaced due to contamination, leakage, consumption and/or breakdown of the fluid. To facilitate fluid replacement, various servicing machines have been devised. Typically, such machines are configured to remove old fluid and refill the system being maintained with new or recycled fluid. To determine the correct fluid type and amount (e.g., mass or volume) an operator may refer to a guide for the vehicle and input the information into the machine. This is a tedious, time-consuming step that is conducive to error. More modern, less widely used, servicing equipment allows a user to manually enter vehicle specifications, such as the make, model and year and/or VIN code. However, this too is a tedious, time-consuming step that is conducive to error.

By way of example and not limitation, automotive air conditioning systems require periodic replenishment of refrigerant. Such systems generally include a compressor for pumping and compressing refrigerant, a condenser for changing refrigerant from a high-pressure gas state to a high-pressure liquid state through condensation, an expansion orifice for rapidly changing the pressure and temperature of the refrigerant, an evaporator for changing refrigerant from a low-pressure liquid state to a low-pressure gas state through evaporation, and an accumulator for storing excess refrigerant, filtering contaminants and removing moisture. A suction line returns the gaseous refrigerant from the accumulator to the compressor. A small amount of oil is suspended in the refrigerant for lubrication of the moving parts of the compressor. The refrigerant level or charge determines the degree of compressor lubrication as well as the cooling performance of the system.

Proper refrigerant charge (the amount of refrigerant and oil contained in the system) is essential for the air conditioning system to operate efficiently. If a significant portion of the refrigerant escapes, compressor lubrication may be insufficient, and continued operation under such conditions could severely damage the compressor. Additionally, a low charge substantially compromises cooling efficiency of the system. Alternatively, if the system is overcharged, the condenser will not dissipate heat.

Current common practices for accurately determining the charge level require evacuating the system and weighing the removed refrigerant, removing existing oil, recovering existing refrigerant, evacuating the system using a deep vacuum, and refilling the system with proper amounts of oil and refrigerant. While commercially available servicing equipment facilitates performing such operations, the equipment does not automatically determine the proper refrigerant charge for a particular vehicle.

Some commercially available refrigerant recharging equipment accommodates manual or optically scanned input of vehicle specifications, e.g., a VIN. Input data is then correlated with charge level data stored in a lookup table or database, to determine the proper charge for a vehicle. Unfortunately, however, as discussed above, manual input and scanning are tedious and conducive to error. Frequently, the 17-character VIN code is improperly entered. Such entry also takes considerable time. Scanning is fraught with complication if the scanner lens is smudged, as is often the case in an automotive garage, or if the barcode to be scanned is marred.

What is needed is a system and method for electronically determining vehicle data, such as a vehicle identification number (VIN), of a serviced vehicle, correlating the data with vehicle fluid requirements, and controlling servicing equipment according to the requirements. The invention is directed to overcoming one or more of the problems and solving one or more of the needs as set forth above.

### SUMMARY OF THE INVENTION

To solve one or more of the problems set forth above, in an exemplary implementation of the invention, a system for electronically determining vehicle data, such as a vehicle identification number (VIN), of a serviced vehicle, correlating the data with vehicle fluid requirements, and controlling servicing equipment according to the requirements, is provided. The system includes an OBD II interface and a module configured to automatically determine vehicle data from the ECU through the OBD II port. The module determines a year, make, model and other information from the data and correlates that information with fluid requirement data for the vehicle. The fluid requirement data is supplied to the microcontroller of a recharging station.

An exemplary system for electronically determining a vehicle identification number from an electronic control unit of a serviced vehicle, correlating the vehicle identification number with vehicle fluid requirements, and controlling fluid servicing equipment according to the requirements, said system is provided. The system includes a communications and processing module configured to communicate a request and receive a response from the vehicle electronic control unit, a data source, and fluid servicing equipment. The communications and processing module is configured to determine fluid requirement data from the data source based upon the response from the vehicle electronic control unit. The data source includes vehicle fluid requirement data correlated with vehicle identification data. The request comprises a vehicle identification number request and the response comprises a vehicle identification number. The communications and processing module is configured to determine vehicle identification data from the vehicle identification number. The fluid servicing equipment is configured to receive fluid requirement data from the communications and processing module. The fluid servicing equipment is also configured to control servicing according to the received fluid requirement data. The fluid requirement data comprises mass data for a fluid from the group consisting of refrigerant, refrigerant oil, brake fluid, differential oil, transmission fluid, power steering fluid, coolant, and motor oil.

An exemplary method for electronically determining a vehicle identification number from an electronic control unit of a serviced vehicle, correlating the vehicle identification number with vehicle fluid requirements, and controlling fluid servicing equipment according to the requirements is also provided. The method includes communicating a request and receiving a response from the vehicle electronic control unit, accessing a data source including fluid requirement data, and determining fluid requirement data from the data source based upon the response from the vehicle electronic control unit. The data source includes vehicle fluid requirement data correlated with vehicle identification data. The request comprises a vehicle identification number request and the response comprises a vehicle identification number. The method further comprises determining vehicle identification data from the vehicle identification number, and receiving fluid requirement data. The method further comprises accessing a data source and determining vehicle fluid requirement data corresponding to the vehicle identification data, communicating fluid requirement data to fluid servicing equipment, and controlling the fluid servicing equipment according to the received fluid requirement data. The fluid requirement data comprises mass data for a fluid from the group consisting of refrigerant, refrigerant oil, brake fluid, differential oil, transmission fluid, power steering fluid, coolant, and motor oil. The step of communicating a request and receiving a response from the vehicle electronic control unit may include communicating a request and receiving a response from the vehicle electronic control unit via an OBD-II port.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a high level block diagram of an exemplary system according to principles of the invention; and

FIG. 2 shows a high level block diagram of an exemplary OBD II module according to principles of the invention; and

FIG. 3 shows a high level flowchart of steps of an exemplary method according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the steps, shapes, relative sizes, ornamental aspects or proportions shown in the figures.

### DETAILED DESCRIPTION

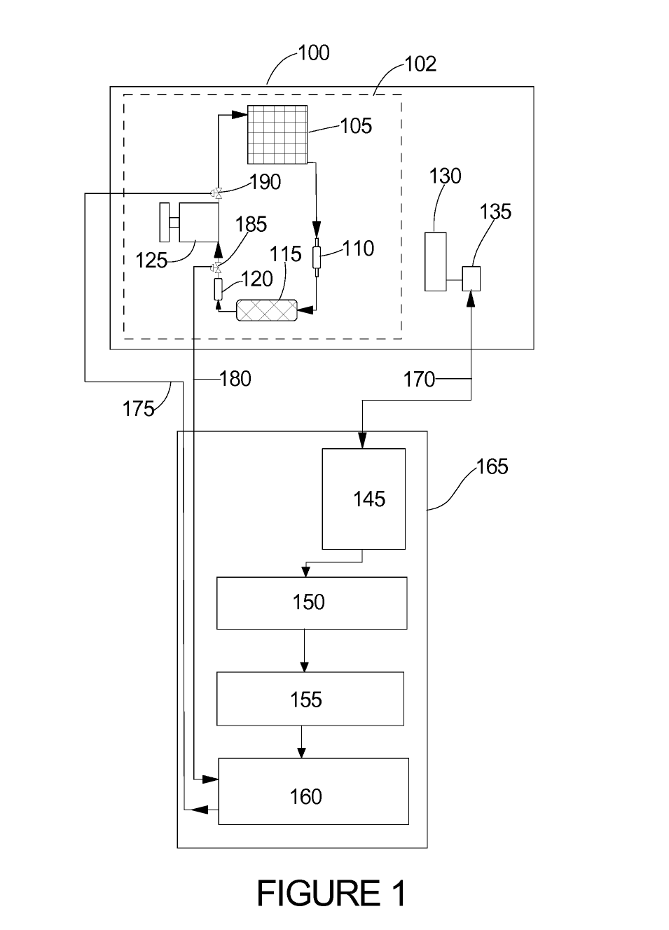

Referring to the Figures, in which like parts are indicated with the same reference numerals, a system and method for electronically determining a vehicle data, such as but not limited to a vehicle identification number (VIN), of a serviced vehicle, correlating the data with vehicle fluid requirements, and controlling servicing equipment according to the requirements, are conceptually shown. Referring to FIG. 1, a motor vehicle is generally designated by reference numeral 100. Among the various fluids of the motor vehicle that require servicing are brake fluid, differential oil, power steering fluid, coolant, motor oil, transmission fluid, and refrigerant and refrigerant oil. For purposes of illustration and not limitation, the following exemplary embodiment focuses primarily on servicing the refrigerant and refrigerant oil of an air conditioning system. However, those skilled in the art will appreciate that principles of the invention apply to servicing of other types of fluid, liquid or gaseous, such as brake fluid, differential oil, power steering fluid, coolant, motor oil and transmission fluid. In each case, a servicing system according to principles of the invention electronically determines vehicle data, such as a vehicle identification number (VIN), of a serviced vehicle, correlates the data with the fluid requirements for the vehicle, and controls the servicing equipment according to the requirements, such that the equipment reintroduces the correct amount (e.g., mass or volume) of fluid or fluids into the serviced system of the vehicle.

Referring to FIG. 1, the exemplary vehicle 100 includes an air conditioning system 102 and an electronic control unit (ECU) 130 coupled to an interface 135. The air conditioning system 102 includes a pulley driven compressor 125, rotatably driven by the vehicle engine with a belt (not shown). The compressor 125 pumps the high-pressure refrigerant vapor to the condenser 105, which is typically located directly behind the vehicle's grille in front of the radiator. As outside air is drawn over the condenser 105 by the engine fan, or forced past it by the ram-air effect, the incoming air absorbs the heat contained in the high-pressure vapor. This causes the vapor to condense into a high-pressure liquid. Thus, the condenser 105 serves as a heat exchanger, changing refrigerant from a high-pressure gas state to a high-pressure liquid state through condensation. As the refrigerant leaves the condenser 105, it proceeds toward the evaporator 115, which is a heat exchanger located within an air handling case along with a blower. Before entering the evaporator 115, the refrigerant flows through a metering device, i.e., an orifice tube 110, which causes a significant drop in pressure, allowing the refrigerant to vaporize at a lower temperature and ensuring that the refrigerant will absorb the maximum amount of heat as the blower forces warm air over the evaporator 115. The evaporator 115 changes the state of refrigerant from low-pressure liquid to low-pressure gas through evaporation. The evaporator 115 has an outlet which is connected to an inlet of accumulator 120. The accumulator 120 contains a desiccant, which attracts moisture, stores excess refrigerant, and filters contaminants. An outlet of the accumulator 120 is fluidly coupled to an inlet of the compressor 125, thus completing a closed cycle. A high pressure side valve 185 and a low pressure side valve 190 are provided for servicing the system.

The principles of the invention are not limited to air conditioning systems, or to any particular air conditioning system. The above-described air conditioning system 102 is an example of a possible air conditioning system and is intended to represent a broad category of air conditioning systems 102 capable of functioning as an air conditioner driven by an engine. Of course, the air conditioning system 102 may include fewer, different and/or additional elements, provided it is capable of performing refrigerant compression and expansion, evaporation and condensation, in accordance with principles of the invention. By way of example and not limitation, in lieu of an orifice tube 110, the system 102 may include an expansion valve, i.e., a variable metering device that varies refrigerant flow based on cooling demand. In such systems, as demand increases, the valve opens wider to permit more refrigerant into the evaporator. Once the demand has been satisfied, the valve opening is reduced to decrease flow. Cooling demand is monitored by a sensing bulb mounted on or near the evaporator. Depending on the vehicle, the A/C system will either have a receiver dryer or an accumulator 120. Both of these components contain a desiccant that attracts moisture. The receiver dryer and accumulator 120 also serve as temporary holding tanks for liquid refrigerant. A receiver dryer is connected to the condenser outlet (high-pressure side) and is used exclusively in expansion valve systems. In contrast, an accumulator 120 is attached to the evaporator outlet (low-pressure side), and is typically only found in orifice tube systems.

The principles of the invention are not limited to any particular refrigerant. CFC refrigerants in common but receding usage include R-11 and R-12. Newer and more environmentally-safe refrigerants include HFCs (e.g., R-134a, used in most cars today). 1,1,2-Tetrafluoroethane, also called simply tetrafluoroethane, R-134a, Genetron 134a, Freon 134a or HFC-134a, is a haloalkane refrigerant without an ozone depletion potential and thermodynamic properties similar to R-12 (dichlorodifluoromethane).

An Engine Control Unit (ECU) 130 also known as an Engine Control Module (ECM) or Powertrain Control Unit/Module (PCU, PCM) is an electronic control unit which controls various aspects of an internal combustion engine's operation. ECUs found on most modern cars control fuel injection, ignition timing, variable valve timing (VVT), the level of boost maintained by a turbocharger (in turbocharged vehicles), and control other peripherals, by monitoring through various sensors. These may include a MAP sensor, throttle position sensor, air temperature sensor, oxygen sensor and many others.

An On-Board Diagnostics interface, or OBD interface 135, is operably coupled to the ECU 130. Since 1996, the OBD-II specification is mandated for all cars sold in the United States. The OBD-II specification defines the type of diagnostic connector and its pin-out, the electrical signaling protocols available, and the messaging format. It also provides a candidate list of vehicle parameters to monitor along with how to encode the data for each. Through the OBD-II interface 135, a device can query the ECU 130. The OBD-II specification provides for a standardized hardware interface with a female 16-pin (2×8) J1962 connector. The SAE J1979 standard defines a method for requesting various diagnostic data and a list of standard parameters that might be available from the ECU. The various parameters that are available are addressed by “parameter identification numbers” or PIDs. According to the OBD-II standard, requests to a vehicle's ECU via the OBD-II port are made up of two bytes (excluding header and CRC bytes). The first byte determines the desired mode of operation, and the second byte is the requested parameter identification (PID) number. The ECU will respond with a two byte acknowledgement and possibly some number of data bytes. For a vehicle identification number (VIN), the mode is 09 and the PID is 02. Five lines are returned comprising ASCII coded VIN characters. However, the invention is not limited the VIN. Any data that is available electronically from the vehicle and can be correlated with fluid requirements may be used.

A computer controlled recovery, recycling and recharging station 165 is adapted to connect to the vehicle's OBD interface 135 and determine the vehicle identification number. As known in the art, a typical station may include a vacuum pump for evacuation, an electronic scale that weighs recovered refrigerant and recharges by weight, a compressor, one or more tanks, a filter/drier, a plurality of valves and hoses, and various sensors, collectively represented as 160 in FIG. 1. These components are managed by a microcontroller 155. One or more fluid lines, such as fluid outlet 175 and inlet 180 lines, fluidly couple the station 165 to the system 102 being serviced. The recovery, recycling and recharging station may include fewer, different and/or additional elements, provided it is capable of performing recovery, recycling and recharging operations, in accordance with principles of the invention.

The computer controlled recovery, recycling and recharging station 165 is adapted to connect to the vehicle's OBD interface 135 using a compatible connector 170. The connector is operably coupled to an OBD II communications and processing module 145. The OBD II communications and processing module 145 may be a separate microcontroller module coupled to the recharging station's circuitry or comprised of components integrated with the circuitry of the recharging station 165.

A data source 150, such as a lookup table or database, is provided or made accessible. In one exemplary embodiment the data source may be provided on a storage device, such as a novolatile memory. By way of example and not limitation, the data source may comprise a data structure, as an array or associative array, that correlates vehicle data, such as VIN code values, with fluid requirements. Illustratively, for a particular year, make, model and engine, as determined from VIN code characters, the data source may provide one or more fluid requirements. In the exemplary embodiment, refrigerant and oil weight requirements for the vehicle 100 may be specified.

A vehicle identification may be determined from the VIN code available from the ECU 130 via the OBD-II port 135. Modern day VINs consist of 17 characters that do not include the letters I, O or Q. The first three characters identify the manufacturer of the vehicle using the World Manufacturer Identifier or WMI code. The 4th through 8th positions in the VIN are the Vehicle Descriptor Section or VDS, which identify the vehicle type, model and body style. Character 9 is a check digit. The 10th through 17th positions are used as the Vehicle Identifier Section or VIS. In North America, character 10 encodes the model year of the vehicle. The 11th character encodes the factory of manufacture of the vehicle. The remaining characters may include information on options installed or engine and transmission choices, but often are a simple sequential number.

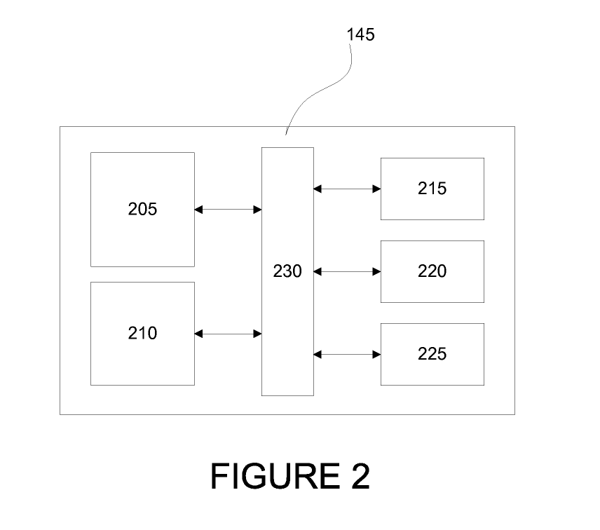

Referring now to FIG. 2, the OBD II communications and processing module 145 communicates with the ECU 130 through a compatible connection 170 coupled to the OBD II interface 135. The OBD II communications and processing module 145 also communicates with the microcontroller 155 of the recharging station 165. The OBD II communications and processing module 145 is configured with a microcontroller 205, a ROM 210 (which may be an integral part of the microcontroller or a separate component), RAM 215, an OBD interface 220 and a recharging station interface 225, all operably coupled by a bus 230. Additional and different input and output ports and other components (e.g., analog-to-digital and/or digital-to-analog converters) may be provided without departing from the scope of the invention. The microcontroller 205 determines a vehicle data, such as a vehicle identification number (VIN), of a serviced vehicle via the ODB II interface 220, correlates the data with vehicle refrigerant requirement data, and communicates the data to the recharging system controller 155. The OBD II interface 220 is releasably coupled to an OBD II port 135. The data source 150 may be provided on a removable and/or permanent nonvolatile storage device such as a novolatile memory.

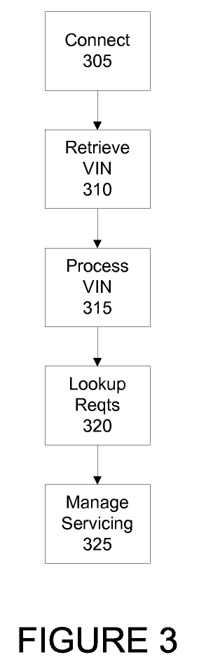

Referring to the flowchart of FIG. 3, a high level flowchart of a method according to principles of the invention is shown. In step 305, the servicing station is connected to the vehicle. In the case of the refrigerant servicing station 165 described above, this step entails connecting the OBD II communications and processing module 145 to the OBD II interface 135, and connecting the fluid outlet 175 and inlet 180 lines to the system 102 being serviced.

After the OBD II communications and processing module 145 is connected to the OBD II interface 135, the vehicle data, such as a vehicle identification number (VIN), is retrieved by the OBD II communications and processing module 145 from the ECU 130. This entails communicating a request (e.g., mode 09, PID 02) to the vehicle's ECU 130 via the OBD-II port 135 causing the ECU to respond with an acknowledgement and coded vehicle data, such as a vehicle identification number (VIN) characters.

After the data is retrieved, it the OBD II communications and processing module 145 parses it in step 315 to determine the characters required for the next step. The characters should provide enough information to determine the fluid requireents for the servicing operation. By way of example and not limitation, VIN characters corresponding to make, model, year and engine may be determined.

After the required characters are determined, the OBD II communications and processing module 145 performs a lookup operation, as in step 320. Lookup entails searching the data source 150 for fluid requirement data that correspond to the characters. Here, the characters are the search criteria and the search result is the fluid requirement data.

Upon determining the fluid requirement data, the data is communicated to the microcontroller 155. The microcontroller controls the servicing operation performed by the vehicle servicing components 160.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A system for electronically determining vehicle data from an electronic control unit of a serviced vehicle, correlating the vehicle data with vehicle fluid requirements, and controlling fluid servicing equipment according to the requirements, said system comprising:
a communications and processing module configured to communicate a request and receive a response from the vehicle electronic control unit, and
a data source, and
fluid servicing equipment, and
said communications and processing module further configured to determine fluid requirement data from the data source based upon the response from the vehicle electronic control unit.

2. A system according to claim 1, wherein:
the data source includes vehicle fluid requirement data correlated with vehicle data obtained from the electronic control unit.

3. A system according to claim 1, wherein:
the request comprises a vehicle identification number request and the response comprises a vehicle identification number.

4. A system according to claim 1, wherein:
the request comprises a vehicle identification number request and the response comprises a vehicle identification number, and
the communications and processing module is configured to determine vehicle identification data from the vehicle identification number, and
the data source includes vehicle fluid requirement data correlated with the vehicle identification data.

5. A system according to claim 1, wherein:
the fluid servicing equipment is configured receive fluid requirement data from the communications and processing module.

6. A system according to claim 1, wherein:
the request comprises a vehicle identification number request and the response comprises a vehicle identification number, and
the communications and processing module is configured to determine vehicle identification data from the vehicle identification number, and
the data source includes vehicle fluid requirement data correlated with the vehicle identification data, and
the communications and processing module is configured to access the data source and determine vehicle fluid requirement data corresponding to the vehicle identification data.

7. A system according to claim 1, wherein:
the request comprises a vehicle identification number request and the response comprises a vehicle identification number, and
the communications and processing module is configured to determine vehicle identification data from the vehicle identification number, and
the data source includes vehicle fluid requirement data correlated with the vehicle identification data, and
the communications and processing module is configured to access the data source and determine vehicle fluid requirement data corresponding to the vehicle identification data, and
the fluid servicing equipment is configured to receive fluid requirement data from the communications and processing module.

8. A system according to claim 1, wherein:
the request comprises a vehicle identification number request and the response comprises a vehicle identification number, and
the communications and processing module is configured to determine vehicle identification data from the vehicle identification number, and
the data source includes vehicle fluid requirement data correlated with the vehicle identification data, and
the communications and processing module is configured to access the data source and determine vehicle fluid requirement data corresponding to the vehicle identification data, and
the fluid servicing equipment is configured to receive fluid requirement data from the communications and processing module, and
the fluid servicing equipment is configured to control servicing according to the received fluid requirement data.

9. A system according to claim 1, wherein:
the request comprises a vehicle identification number request and the response comprises a vehicle identification number, and
the communications and processing module is configured to determine vehicle identification data from the vehicle identification number, and
the data source includes vehicle fluid requirement data correlated with the vehicle identification data, and
the communications and processing module is configured to access the data source and determine vehicle fluid requirement data corresponding to the vehicle identification data, and
the fluid servicing equipment is configured to receive fluid requirement data from the communications and processing module, and
the fluid servicing equipment is configured to control servicing according to the received fluid requirement data, and
the fluid requirement data comprises mass data for a fluid from the group consisting of refrigerant, refrigerant oil, brake fluid, differential oil, transmission fluid, power steering fluid, coolant, and motor oil.

10. A system according to claim 1, further comprising an OBD-II port communicatively coupled to the electronic control unit, wherein:
the communications and processing module is releasably communicatively coupled to the OBD-II port and configured to determine vehicle identification data from the vehicle identification number, and
the data source includes vehicle fluid requirement data correlated with the vehicle identification data, and
the communications and processing module is configured to access the data source and determine vehicle fluid requirement data corresponding to the vehicle identification data, and
the fluid servicing equipment is configured to receive fluid requirement data from the communications and processing module, and
the fluid servicing equipment is configured to control servicing according to the received fluid requirement data.

11. A method for electronically determining a vehicle identification number from an electronic control unit of a serviced vehicle, correlating the vehicle identification number with vehicle fluid requirements, and controlling fluid servicing equipment according to the requirements, said method comprising:
communicating a request and receiving a response from the vehicle electronic control unit, and
accessing a data source including fluid requirement data, and
determining fluid requirement data from the data source based upon the response from the vehicle electronic control unit.

12. A method according to claim 11, wherein:
the data source includes vehicle fluid requirement data correlated with vehicle identification data.

13. A method according to claim 11, wherein:
the request comprises a vehicle identification number request and the response comprises a vehicle identification number.

14. A method according to claim 11, wherein:
the request comprises a vehicle identification number request and the response comprises a vehicle identification number, and
the method further comprises determining vehicle identification data from the vehicle identification number, and
the data source includes vehicle fluid requirement data correlated with the vehicle identification data.

15. A method according to claim 11, further comprising:
receiving fluid requirement data.

16. A method according to claim 11, wherein:
the method further comprises determining vehicle identification data from the vehicle identification number, and
the data source includes vehicle fluid requirement data correlated with the vehicle identification data, and
the method further comprises accessing a data source and determining vehicle fluid requirement data corresponding to the vehicle identification data.

17. A method according to claim 11, wherein:
the method further comprises determining vehicle identification data from the vehicle identification number, and
the data source includes vehicle fluid requirement data correlated with the vehicle identification data, and
the method further comprises accessing a data source and determining vehicle fluid requirement data corresponding to the vehicle identification data, and
communicating fluid requirement data to fluid servicing equipment.

18. A method according to claim 11, wherein:
the method further comprises determining vehicle identification data from the vehicle identification number, and
the data source includes vehicle fluid requirement data correlated with the vehicle identification data, and
the method further comprises accessing a data source and determining vehicle fluid requirement data corresponding to the vehicle identification data, and
communicating fluid requirement data to fluid servicing equipment, and
controlling the fluid servicing equipment according to the received fluid requirement data.

19. A method according to claim 11, wherein:
the method further comprises determining vehicle identification data from the vehicle identification number, and
the data source includes vehicle fluid requirement data correlated with the vehicle identification data, and
the method further comprises accessing a data source and determining vehicle fluid requirement data corresponding to the vehicle identification data, and
communicating fluid requirement data to fluid servicing equipment, and
controlling the fluid servicing equipment according to the received fluid requirement data, and
the fluid requirement data comprising mass data for a fluid from the group consisting of refrigerant, refrigerant oil, brake fluid, differential oil, transmission fluid, power steering fluid, coolant, and motor oil.

20. A method according to claim 11, wherein:
the step of communicating a request and receiving a response from the vehicle electronic control unit comprises communicating a request and receiving a response from the vehicle electronic control unit via an OBD-II port, and
the method further comprises determining vehicle identification data from the vehicle identification number, and
the data source includes vehicle fluid requirement data correlated with the vehicle identification data, and
the method further comprises accessing a data source and determining vehicle fluid requirement data corresponding to the vehicle identification data, and
communicating fluid requirement data to fluid servicing equipment, and
controlling the fluid servicing equipment according to the received fluid requirement data.
